(19) United States
(12) Patent Application Publication
(10) Pub. No.: US 2023/0166339 A1
(43) Pub. Date: Jun. 1, 2023

(54) HYDRAULIC EXPANSION CHUCKS

(71) Applicant: Guehring KG, Albstadt (DE)

(72) Inventor: Klaus MATHEIS, Sauldorf/Rast (DE)

(73) Assignee: Guehring KG, Albstadt (DE)

(21) Appl. No.: 17/935,234

(22) Filed: Sep. 26, 2022

Related U.S. Application Data
(63) Continuation of application No. PCT/DE2021/100187, filed on Feb. 25, 2021.

(30) Foreign Application Priority Data
Mar. 27, 2020 (DE) 10 2020 108 558.3

(51) Int. Cl. B23B 31/30

(52) U.S. Cl. CPC B23B 31/305

(57) ABSTRACT

The application relates to hydraulic expansion chucks (1) for accommodating a machining tool (0), comprising a main chuck body (2) with a substantially cylindrical cavity (21), and comprising a bushing (3) with a first portion (31) and a second portion (32), wherein the entire first portion (31) is located within the cavity (21) of the main chuck body (2), while the entire second portion (31) is located outside the cavity (21) of the main chuck body (2).

The invention relates to a hydraulic expansion chuck for accommodating a tool, in particular for a machining tool.

The use of hydraulic expansion chucks is widespread. Conventional hydraulic expansion chucks are constructed in one piece and have a pivot bushing, which serves the purpose of clamping a tool, as well as a machine-side connection. To brace the tool, a fluid is introduced into chambers of the pivot bushing, which fill up and expand under pressure. Due to the expansion of these chambers, the tool, which is introduced into the tool chuck, is clamped. Hydraulic expansion chucks clamp a tool, when a chamber or a line bulges in the direction of the tool to be accommodated and thus exerts a clamping force on the tool shaft. An unclamping of the tool takes place by discharging the fluid.

In the prior art, a hydraulic expansion chuck for accommodating and clamping machining tools is described, for example, in DE 10 2015 120 971 A1. It comprises a main chuck body with a separate clamping bushing, on the front end of which the shaft of a machining tool is clamped. Coaxial chambers, into which a fluid is admitted under pressure in order to bulge the chambers outwards, is arranged within the wall of the front part.

It is a disadvantage of these known multi-part hydraulic expansion chucks that the front part for accommodating the tool is arranged completely outside the main chuck body because the shaft of the tool can be clamped therein asymmetrically. Even the smallest deviations from the symmetry have a strong impact on the smooth operation and thus on the machining quality of the tool.

It is the object of the present invention to provide a hydraulic expansion chuck, which overcomes the disadvantages from the prior art and which is suitable to optimally clamp the shaft of a machining tool.

The invention comprises a hydraulic expansion chuck for accommodating a machining tool comprising a main chuck body with an essentially cylindrical cavity and a bushing with a first portion and a second portion, wherein the first portion is arranged completely within the cavity of the main chuck body, and wherein the second portion is arranged completely outside the cavity of the main chuck body. The arrangement of the first portion in the cavity of the main chuck body allows for a secure centering and ensures a very smooth operation.

According to an advantageous aspect, the bushing comprises at least one chamber for accommodating a fluid. The chamber is formed in order to bulge during the pressurized admittance of the fluid and in order to decrease a cross section of the cavity at least in sections. The cross section of the cavity can thereby be decreased between 0.01 mm and 0.1 mm in order to optimally clamp the shaft of the machining tool. The at least one chamber can thereby be arranged within the first portion and/or the second portion.

According to another advantageous aspect, the bushing comprises at least one fluid inlet, which fluid inlet connects an outer side of the bushing to the at least one chamber. The fluid inlet can thereby have a diameter of between 0.1 mm and 2.0 mm.

On the outer side of the bushing, the fluid inlet is advantageously connected to a fluid feed via an annular channel. The annular channel can be formed in a completely circumferential manner.

According to a preferred aspect, the bushing comprises at least a first chamber, which is arranged within the first portion of the bushing, and a second chamber, which is arranged within the second portion of the bushing. The first chamber can thereby be arranged completely within the first portion, and the second chamber completely within the second portion.

According to a further preferred aspect, the bushing comprises at least one channel, which connects the first chamber and the second chamber. The at least one channel can thereby be arranged between the first portion and the second portion.

According to a particularly preferred aspect, the first portion has a length L₁ and the second portion has a length L₂. The ratio L₁ : L₂ is thereby between 1 : 1 and 3 : 1. The length L₂ can thereby be between 5 mm and 50 mm.

According to an advantageous aspect, the bushing has a first wall thickness D₁ along the first portion and a second wall thickness D₂ along the second portion. The ratio D₁ : D₂ is thereby between 1 : 3 and 1 : 1.1. The wall thickness D₂ can thereby be between 2 mm and 10 mm.

According to a further advantageous aspect, the at least one chamber is arranged in the bushing between 0.1 mm and 1.0 mm spaced apart from an inner side of the bushing.

According to a particularly advantageous aspect, an essentially L-shaped stop is arranged on the outer side of the bushing between the first portion and the second portion. The essentially L-shaped stop is thereby formed in order to stop against an edge end portion of the cavity of the main chuck body in the installed state of the bushing into the main chuck body.

According to another preferred aspect, an inner edge portion for positively accommodating an outer edge portion of a shaft portion of the machining tool is arranged on the inner side of the bushing. The inner edge portion can thereby be a non-circular tapering of the essentially cylindrical cavity.

The invention will be described in more detail below on the basis of the examples illustrated in the enclosed drawings. Identical reference numerals relate to the same features in all figures, in which:

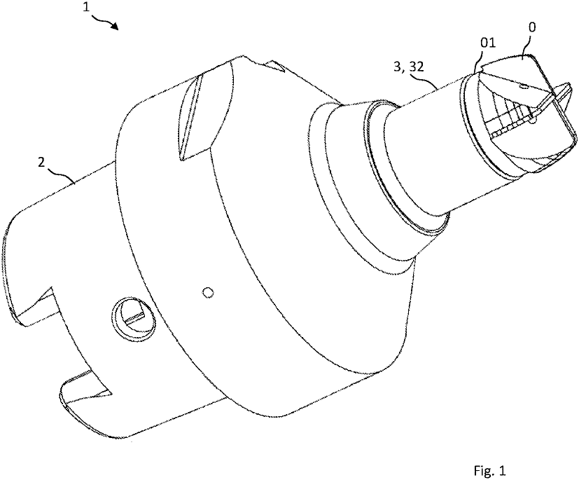

FIG. 1 shows a perspective view of a hydraulic expansion chuck according to the invention; and

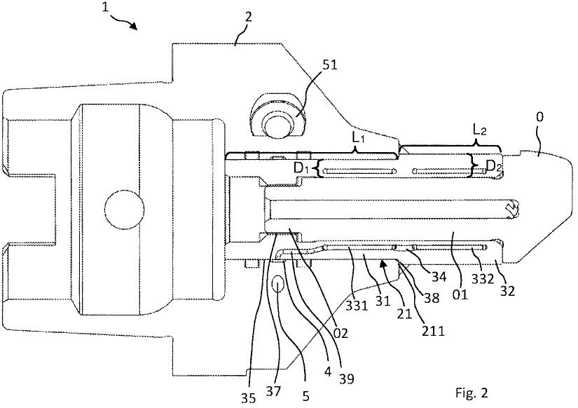

FIG. 2 shows a sectional view of the hydraulic expansion chuck from FIG. 1;

FIG. 1 shows a perspective view of a hydraulic expansion chuck 1 according to the invention. In the illustrated example, the hydraulic expansion chuck 1 accommodates a machining tool 0.

The hydraulic expansion chuck 1 thereby comprises a main chuck body 2. The main chuck body 2 has an essentially cylindrical cavity 21 (shown in FIG. 2). The hydraulic expansion chuck 1 furthermore comprises a bushing 3 with a first portion 31 (shown in FIG. 2), which is arranged completely within the cavity 21 (shown in FIG. 2) of the main chuck body 2, and a second portion 32, which is arranged completely outside the cavity 21 (shown in FIG. 2) of the main chuck body 2. The length of the second portion 32, which is arranged completely outside the cavity 21 of the main chuck body 2, can thereby be adapted to the machining tool 0, independently of the length of the cavity 21 (shown in FIG. 2) in order to optimally clamp the shaft 01 of the machining tool 0 according to the length of the shaft 01.

FIG. 2 shows a sectional view of the hydraulic expansion chuck 1 from FIG. 1.

In the shown example, the hydraulic expansion chuck 1 accommodates a machining tool 0. The main chuck body 2 comprises an essentially cylindrical cavity 21 and a bushing 3 with a first portion 31 and a second portion 32. The first portion 31 is thereby arranged completely within the cavity 21 of the main chuck body 2, and the second portion 32 is arranged completely outside the cavity 21 of the main chuck body 2. The length of the second portion 32, which is arranged completely outside the cavity 21 of the main chuck body 2, was thereby adapted to the machining tool in order to optimally clamp the shaft the machining tool according to the length of the shaft. This length can be selected independently of the length of the cavity 21.

According to another advantageous aspect, the bushing 3 comprises at least one fluid inlet 39, which fluid inlet 39 connects an outer side 35 of the bushing 3 to the at least one chamber 33. The fluid inlet 39 can thereby have a diameter of between 0.1 mm and 2.0 mm.

The fluid inlet 39 is connected to a fluid feed 5 via the outer side 35 of the bushing 3 with an annular channel 4. The fluid feed 5 can be connected to a fluid source (hydraulic hose) via a valve 51.

The bushing 3 comprises a first chamber 331, which is arranged within the first portion 31 of the bushing 3, and a second chamber 332, which is arranged within the second portion 32 of the bushing 3. The first chamber 331 is thereby arranged completely within the first portion 31, and the second chamber 332 completely within the second portion 32. The first and the second chamber 331, 332 are formed in order to bulge during the pressurized inlet of the fluid and in order to decrease the cross section of the cavity 21 in sections. The cross section of the cavity 21 is thereby decreased by 0.05 mm in order to optimally clamp the shaft of the machining tool.

The bushing 3 comprises a channel 34, which connects the first chamber 331 and the second chamber 332. The channel 34 is thereby arranged between the first portion 31 and the second portion 32.

The first portion 31 has a length L₁ and the second portion 32 has a length L₂. The ratio is thereby L₁ : L₂ = 1.5 : 1. The length L₂ is thereby 15 mm.

The bushing 3 has a first wall thickness D₁ along the first portion 31 and a second wall thickness D₂ along the second portion 32. The ratio is thereby D₁ : D₂ = 1 : 1.2. The wall thickness D₂ is thereby 4 mm.

The first and the second chamber 331, 332 are in each case arranged in the bushing 3 0.2 mm spaced apart from an inner side 36 of the bushing 3.

An essentially L-shaped stop 38 is arranged on the outer side 35 of the bushing 3 between the first portion 31 and the second portion 32. The essentially L-shaped stop 38 is thereby formed in order to stop against an edge end portion 211 of the cavity 21 of the main chuck body 2 in the installed state of the bushing 3 into the main chuck body 2.

An inner edge portion 37 for positively accommodating an outer edge portion 02 of a shaft portion 01 of the machining tool 0 is arranged on the inner side 36 of the bushing 3. The inner edge portion 37 is formed as non-circular tapering of the essentially cylindrical cavity 21.

1. A hydraulic expansion chuck for accommodating a machining tool comprising a main chuck body with an essentially cylindrical cavity and a bushing with a first portion and a second portion, wherein the first portion is arranged completely within the cavity of the main chuck body, and wherein the second portion is arranged completely outside the cavity of the main chuck body.

2. The hydraulic expansion chuck according to claim 1, wherein the bushing comprises at least one chamber for accommodating a fluid, which chamber is formed in order to bulge during the pressurized admittance of the fluid and in order to decrease a cross section of the cavity at least in sections.

3. The hydraulic expansion chuck according to claim 2, wherein the bushing comprises at least one fluid inlet, which fluid inlet connects an outer side of the bushing to the at least one chamber.

4. The hydraulic expansion chuck according to claim 3, wherein on the outer side of the bushing, the fluid inlet is connected to a fluid feed via an annular channel.

5. The hydraulic expansion chuck according to claim 1, wherein the bushing comprises at least a first chamber, which is arranged within the first portion of the bushing, and comprises a second chamber, which is arranged within the second portion of the bushing.

6. The hydraulic expansion chuck according to claim 5, wherein the bushing comprises at least one channel, which connects the first chamber and the second chamber.

7. The hydraulic expansion chuck according to claim 1, wherein the first portion has a length L₁ and the second portion has a length L₂, wherein the ratio L₁ : L₂ is between 1 : 1 and 3 : 1.

8. The hydraulic expansion chuck according to claim 1, wherein the bushing has a first wall thickness D₁ along the first portion and a second wall thickness D₂ along the second portion, wherein the ratio D₁ : D₂ is between 1 : 3 and 1 : 1.1.

9. The hydraulic expansion chuck according to claim 2, wherein the at least one chamber is arranged in the bushing between 0.1 mm and 1.0 mm spaced apart from an inner side of the bushing.

10. The hydraulic expansion chuck according to claim 3, wherein an essentially L-shaped stop is arranged on the outer side of the bushing between the first portion and the second portion, said stop being formed in order to stop against an edge end portion of the cavity of the main chuck body in the installed state of the bushing into the main chuck body.

11. The hydraulic expansion chuck according to claim 1, wherein an inner edge portion for positively accommodating an outer edge portion of a shaft portion of the machining tool is arranged on the inner side of the bushing.
